(19) United States
(12) Patent Application Publication
(10) Pub. No.: US 2018/0213807 A1
(43) Pub. Date: Aug. 2, 2018

(54) METHODS AND COMPOSITIONS FOR STORAGE AND TRANSPORTATION OF FRESH FOOD

(71) Applicant: SEA FOAM SYSTEMS CORP., Vancouver (CA)

(72) Inventors: Scott MCKINLEY, West Vancouver (CA); Fraser RIECHE, Vancouver (CA)

(21) Appl. No.: 15/739,621

(22) PCT Filed: Jul. 8, 2016
(86) PCT No.: PCT/CA2016/050802

§ 371 Date: Dec. 22, 2017

Related U.S. Application Data
(60) Provisional application No. 62/190,490, filed on Jul. 9, 2015.
(60) Provisional application No. 62/254,167, filed on Nov. 11, 2015.

(51) Int. Cl. A23B 4/10; A23B 4/20; B65D 81/20; B65D 85/50

(52) U.S. Cl. CPC A23B 4/10; B65D 85/50; B65D 81/2007; A23B 4/20

(57) ABSTRACT

A method for storing and transporting fresh food is provided. The method includes the steps of: placing fresh food in a receptacle suitable for storing and transporting fresh food; providing a foam composition including a food grade surfactant, a gas, and an aqueous carrier; and at least partially covering the fresh food with the foam composition. The fresh food may be live seafood, meat, produce or processed food.

### TECHNICAL FIELD

This invention relates to methods and compositions for storing and transporting fresh food.

### BACKGROUND

Maintaining freshness of fresh food during storage and transportation poses challenges. Modern packaging systems have been developed to prevent spoilage, and ensure quality and safety of fresh food. Examples of modern packaging systems include sealed systems such as vacuum packaging and modified atmosphere packaging.

Fresh food is typically subjected to some intermediate storage or packaging operation prior to being packaged in individual packages for, or presented in bulk form to, the consumer. The intermediate storage or packaging operation may occur, for example, at a point of origin of the fresh food (e.g. point of harvest, slaughter or production) and/or at a centralized distribution point. Packaging systems such as vacuum packaging and modified atmosphere packaging may be impractical or costly at the intermediate storage or packaging stage. Improved and cost-effective approaches to storing and transporting fresh food during intermediate storage or packaging to maintain freshness of fresh food are desirable.

An example of fresh food with particularly challenging storage and transportation requirements is live seafood, including but not limited to finfish and shellfish. Live seafood has high mortality rates and relatively short survival times, particularly when water is removed. While transportation in water can mitigate these issues this is usually impractical due to prohibitive transportation costs associated with the weight of water. Cost-effective approaches to storing and transporting live seafood that reduce mortality and prolong survival are also desirable.

### SUMMARY

The inventions described herein have many aspects, some of which relate to compositions and methods for storing and transporting fresh food.

According to one aspect, a method for storing and transporting fresh food is provided. The method comprises:
a) placing fresh food in a receptacle suitable for storing and transporting fresh food;
b) providing a foam composition comprising:
   a. a food grade surfactant;
   b. a gas;
   c. an aqueous carrier; and
c) at least partially covering the fresh food with the foam composition.

According to another aspect, a method for storing and transporting fresh food is provided. The method comprises:
a) placing fresh food in a receptacle suitable for storing and transporting fresh food;
b) generating a foam composition from a foam generator that adds a gas to a liquid concentrated foaming composition comprising:
   a. a food grade surfactant;
   b. an aqueous carrier;
c) at least partially covering the fresh food with the foam composition.

According to another aspect, a method for storing and transporting fresh food is provided. The method comprises:
a) placing fresh food in a receptacle suitable for storing and transporting fresh food;
b) generating a foam composition by adding an aqueous carrier to a dry foaming composition comprising a food grade surfactant; and
c) at least partially covering the fresh food with the foam composition.

Methods according to the foregoing aspects further comprise a step d) of removing air from between the fresh food under the cover of the foam composition. Step d) may comprise replacing the air with nitrogen, carbon dioxide, argon, carbon monoxide, or mixtures thereof.

In the methods according to the foregoing aspects the gas may comprise nitrogen, carbon dioxide, argon, carbon monoxide, or mixtures thereof, but excludes oxygen.

In the methods according to the foregoing aspects the gas may comprise oxygen.

In the methods according to the foregoing aspects the food grade surfactant may comprise a native protein is selected from the group consisting of frog-derived proteins, carbohydrate-binding proteins, hydrophobins and caseins. The frog-derived protein may be a ranasmurfin or a ranaspumin. The carbohydrate-binding protein may be a lectin or a mucin. The food grade surfactant may comprise a denatured protein selected from the group consisting of soy, whey and albumin. The surfactant may comprise an antimicrobial protein. The food grade surfactant may comprise a carbohydrate or a lipid. The aqueous carrier may comprise fresh water or salt water.

In the methods according to the foregoing aspects the foam composition may further comprise a food grade antimicrobial agent.

In the methods according to the foregoing aspects the foam composition of step b) may be provided or generated to have one or more predetermined characteristics based on the type of fresh food of step b). The one or more predetermined characteristics may be selected from the group consisting of overrun, yield stress, pH and salinity.

In the methods according to the foregoing aspects the receptacle may be a box, a tote, a bag or a storage chamber. The receptacle may comprise an interior comprising a smooth surface, a coating providing a smooth surface, or a liner with a smooth surface.

In the methods according to the foregoing aspects, the fresh food may be selected from the group consisting of live seafood, meat, produce and processed food.

According to another aspect, a foam composition for storing and transporting fresh food is provided. The foam composition comprises:
a) a food grade surfactant;
b) a gas; and
c) an aqueous carrier.

The gas may comprise nitrogen, carbon dioxide, argon, carbon monoxide, or mixtures thereof, but excludes oxygen. The gas may comprise oxygen.

According to another aspect, a liquid concentrated foam composition for storing and transporting fresh food is provided. The liquid concentrated foam composition comprises:
a) a food grade surfactant; and
b) an aqueous carrier.

According to another aspect, a dry foaming composition for storing and transporting fresh food is provided. The dry foaming composition comprises a food grade surfactant.

In the compositions according to the foregoing aspects, the food grade surfactant may comprise a native protein is selected from the group consisting of frog-derived proteins, carbohydrate-binding proteins, hydrophobins and caseins.

The frog-derived protein may be a ranasmurfin or a ranaspumin. The carbohydrate-binding protein may be a lectin or a mucin. The food grade surfactant may comprise a denatured protein selected from the group consisting of soy, whey and albumin. The surfactant may comprise an antimicrobial protein. The food grade surfactant may comprise a carbohydrate or a lipid. The aqueous carrier may comprise fresh water or salt water.

In the compositions according to the foregoing aspects the foam composition may further comprise a food grade antimicrobial agent.

The foregoing discussion merely summarizes certain aspects of the inventions and is not intended, nor should it be construed, as limiting the inventions in any way.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The term “fresh food” as used in this specification includes:
Fresh meats (e.g. beef, chicken, fish, lamb, mutton, pork, lamb, seafood, turkey, veal, and the like). In some embodiments, fresh meat may be in the form of a carcass, a primal cut, or a finished cut.
Fresh produce (e.g. vegetables, fruits, mushrooms, and the like). In some embodiments, fresh produce may be whole, peeled, cored, and/or cut.
Fresh processed foods (e.g. pastas, cheeses, cured meats, and the like).
   The term “fresh food” also includes previously frozen meats, produce and processed foods.

The term “seafood” as used in this specification refers to the marine and fresh water species in:
Phylum Arthropoda, Class Malacostraca, Orders Decapoda and Euphausiacea (e.g. shrimp, crayfish, lobsters and crabs).
Phylum Mollusca, Classes Bivalvia, Gastropoda and Cephalopoda (e.g. shellfish).
Phylum Echinodermata, Classes Echinoidea and Holothuroidea (e.g. sea urchins and sea cucumbers).
Phylum Chordata, Class Actinopterygii, Orders Pleuronectiformes, Perciformes, Scorpaeniformes, Gadiformes, Anguilliformes (e.g. pelagic fish, demersal fish and reef fish).

The term “food grade surfactant” as used in this specification means a surfactant that up to specified amounts can be ingested by a human without generally causing deleterious health effects.

The term “smooth surface” means a surface of sufficient smoothness to minimize or eliminate bursting of foam bubbles in contact with the surface.

Claims of the invention relate to methods for storing and transporting fresh food.

In some embodiments the method comprises placing fresh food in a suitable receptacle and at least partially filling the receptacle with a foam composition comprising a food grade protein and/or a food grade surfactant, a gas, and an aqueous carrier, as described herein. In some embodiments the method is performed as an intermediate storage or packaging operation, prior to final packaging for or bulk provision to the consumer.

In some embodiments the fresh food may be placed in the receptacle and then the foam composition added over top to cover the fresh food. In some embodiments the receptacle may be at least partially filled with the foam composition and then the fresh food placed in the foam-filled receptacle. In some embodiments the fresh food and foam composition may be added simultaneously to the receptacle. In some embodiments the fresh food and foam composition may be added in alternating sequence to the receptacle.

In some embodiments, the foam composition covers the fresh food completely to provide a foam composition barrier between the fresh food and the remaining volume of the receptacle and/or the environment outside the receptacle. The foam composition barrier can therefore act as an alternative for the sealing member (e.g. semipermeable film) of modified atmosphere packaging (MAP) systems. This can be particularly advantageous, for example, where the receptacle is an open ended receptacle that is shaped or dimensioned in a manner not suitable for sealing with a conventional sealing member. For example, intermediate storage or packaging operations typically involve large receptacles that may be too costly or unwieldly to seal with a sealing member; such receptacles could be advantageously provided with a modified atmosphere by providing a foam composition to completely cover the fresh food therein.

A receptacle environment containing fresh food may be “sealed” by a foam composition barrier and a modified atmosphere to maintain the freshness of the fresh food may be maintained by either or both of: (i) the foam composition itself, with by forming foam bubbles incorporating modified atmosphere gases (as described herein) with the gradual (and in some embodiments, controlled) bursting of these foam bubbles; and (ii) direct injection of modified atmosphere gases (as described herein) below the foam layer (and in some embodiments, with prior evacuation of air from below the foam layer). In some embodiments the foam composition may be formulated to allow selective permeation of specific gases through the foam layer to maintain a predetermined modified atmosphere suitable for a specific fresh food.

In some embodiments, a refrigerant may also be added to the receptacle to keep the fresh food cool. Non-limiting examples of refrigerants include gel packs, ice, dry ice and the like. In some embodiments the refrigerant may be placed at the bottom of the receptacle before filling the receptacle with foam and fresh food. In some embodiments the refrigerant placed at the bottom of the receptacle may be covered with a barrier material to prevent direct contact between the fresh food and the refrigerant. In some embodiments the refrigerant may be placed in one or more other locations within the receptacle and optionally covered with or wrapped in a barrier material. In some embodiments the barrier material may be a plastic sheet material such as PVC sheeting. In some embodiments the receptacles may be placed in a refrigerated environment during storage and/or transportation.

In some embodiments, the foam and fresh food within the receptacle may be compartmentalized into layers by a separating material. For example, foam and fresh food may be arranged at a bottom of the receptacle to form a first layer. A separating material may then be placed on the first layer. Next, additional foam and additional fresh food may be arranged on the separating material to form a second layer. A separating material may then be placed on the second layer, and so on. Each layer may consist of one or more different types of fresh food. The separating material may be a plastic sheet material such as perforated PVC sheeting.

In some embodiments, after the foam and fresh food have been placed in the receptacle and the foam completely covers the fresh food, air may be drawn out from below the foam and the spaces between the fresh food to reduce the amount of air (including oxygen) exposed to the fresh food. Air may be drawn out by suitable means such as a tube attached to a vacuum source. In some embodiments, after the foam covers the fresh food, the air from below the foam and the spaces between the fresh food may be flushed out and replaced with a gas or mixture of gases that correspond to the gas or mixture of gases used to form the foam composition, as described herein.

In some embodiments, the volume of foam added to cover the fresh food may be predetermined. For example, a particular volume of foam may be added to the receptacle depending on factors such as the type of fresh food, the amount of fresh food, the age of the fresh food, the form of transportation, the anticipated storage and transportation time, and the like.

In some embodiments, for example wherein the fresh food is seafood, the volume of foam added to the receptacle per unit mass of live seafood may be predetermined. For example, for a particular species of live seafood, a particular volume of foam may be added to the receptacle per kilogram of live seafood. In some embodiments, the weight per volume of foam added to the receptacle may be limited to be no greater than 10%, or no greater than 5%, or no greater than 3%.

In some embodiments the receptacle may be a box, a tote, a bag or a storage chamber, depending on factors such as the type of fresh food, the amount of fresh food, the age of the fresh food, the form of transportation, the anticipated storage and transportation time, and the like. In some embodiments, the receptacle may have an interior comprising a smooth surface, a coating providing a smooth surface, or a liner with a smooth surface. The smooth surface may comprise a wax coating or wax liner, for example. In some embodiments, the receptacle comprises a gas permeable lining capable of maintaining a modified atmosphere within the volume occupied by the fresh food and completely covered by the foam composition.

In some embodiments the method may include adding to the foam composition additional components such as antimicrobial agents, foam stabilizers, emulsifiers, and the like.

In some embodiments, for example wherein the fresh food is seafood, the method may include adding an additional transportation medium to the receptacle, such as water (saline or freshwater), wet seaweed, wet newspaper and/or sawdust.

In some embodiments the foam composition may be formulated with one or more predetermined factors set at values or value ranges based on the type of fresh food (e.g. species of the seafood). Examples of these factors of the foam composition include one or more of overrun, yield stress, pH and salinity of the foam.

In some embodiments, the foam composition may be premade and used directly by the user. The foam generated by the foam generator is then used to at least partially fill the receptacle. In some embodiments the receptacle may be completely filled with the foam. In some embodiments the foam may be directed into the receptacle below, beside, between and/or on top of the fresh food. In some embodiments the foam may be directed only on top of the fresh food to completely cover the fresh food.

In some embodiments, the foam may be generated by a user adding a liquid foam concentrate composition to a foam generator. The liquid foam concentrate composition may comprise a food grade surfactant and an aqueous carrier. The foam generator aerates the liquid concentrated foaming composition with a suitable propellant such a compressed gas to generate foam. The foam generated by the foam generator is then used to at least partially fill the receptacle. In some embodiments the receptacle may be completely filled with the foam. In some embodiments the foam may be directed into the receptacle below, beside, between and/or on top of the fresh food. In some embodiments the foam may be directed only on top of the fresh food to completely cover the fresh food.

In some embodiments, the foam may be generated by a user adding an aqueous carrier to a dry foaming composition. The dry foaming composition may comprise a food grade surfactant. The foam generated by adding the aqueous carrier to the dry foaming composition is used to at least partially fill the receptacle with the foam composition. In some embodiments the receptacle may be completely filled with the foam. In some embodiments the foam is directed into the receptacle below, beside, between and/or on top of the fresh food. In some embodiments the foam may be directed only on top of the fresh food to completely cover the fresh food.

In some embodiments, after storage and/or transportation, and prior to distribution to consumers, the foam composition may be removed from the fresh food. In some embodiments the removal step may comprise rinsing the foam composition and/or foam composition residue off the fresh food, for example by spraying the fresh food with water (or other suitable aqueous medium) or submerging the fresh food in water (or other suitable aqueous medium).

Claims of the invention relate to foam compositions for storing and transporting fresh food.

In some embodiments, the foam composition comprises a food grade surfactant, a gas, and an aqueous carrier.

The foamed compositions may be provided in a foamed form, but it is also possible to prepare a non-aerated product which is foamed some time or immediately before use. In some embodiments the composition may be provided in non-aerated forms such as a liquid concentrate foaming composition or a dry foaming composition.

A liquid concentrate foaming composition may comprise a food grade surfactant and an aqueous carrier. As described above, the liquid concentrate foaming composition may be released as a foam composition from a suitable foam generating device capable of aerating the liquid concentrate foaming composition.

A dry foaming composition may comprise a food grade surfactant. As described above, the dry foaming composition may be combined with an aqueous carrier in the presence of a gas to generate foam.

In some embodiments, the food grade surfactant may be a native protein. The term “native protein” as used herein refers to a protein, which in its properly folded and/or assembled form, is functional as a surfactant by accumulating at the gas-liquid interface. In some embodiments, the native protein may be a frog-derived protein, a carbohydrate-binding protein, a hydrophobins or a casein.

In some embodiments the frog-derived protein may be a ranaspumin, derived from tropical frogs such as Engystomops pustulosus and Chiromantis xerampelina. Exemplary ranaspumins include RSN 1, RSN 2, RSN 3, RSN 4, RSN 5, RSN 6, and LV-ranaspumin. In some embodiments, the frog-derived protein may be ranasmurfin, derived from the Polypedates leucomystax. In some embodiments, the frog-derived protein may be synthetic equivalents or synthetic derivatives of the foregoing proteins.

In some embodiments, the carbohydrate-binding protein may be a lectin or a mucin. Carbohydrate binding proteins have the advantage of forming non-covalent bonds to provide a stabilizing matrix that aids foam stability and water retention.

In some embodiments the food grade surfactant may be a denatured protein, that is, a protein which in its denatured state acts as a surfactant by accumulating at the gas-liquid interface. In some embodiments the denatured protein may be denatured soy, denatured whey or denatured albumin.

In some embodiments the food grade surfactant may be any food grade protein. Non-limiting examples of food grade proteins include algal proteins, microalgal proteins, gelatins, gluten, casein, and the like. In some embodiments the food grade protein may be in its denatured form.

In some embodiments the food grade surfactant may be a protein with antimicrobial properties, to protect the fresh food from decay and infection.

In some embodiments, the concentration of protein in the liquid portion of the foam may range from 0.1 to 10 mg/mL, or 0.5 to 8 mg/mL, or 1 to 5 mg/mL.

In some embodiments, the surfactant action of the composition may be additionally or alternatively provided by a carbohydrate or a lipid (e.g. glycolipid). Non-limiting examples of suitable non-protein food grade surfactants include acetylated monoglycerides, alkyl or alkenyl sugar esters, bile salts, cellulose derivatives, diglycerides, ethoxylated glyceryl esters, fatty acid ethoxylates, hydroxylated phospholipids, lecithin, monoglycerides, polyglycerols, polyoxystearates, saponins, sorbitan esters, stearyl-2-lactylic acid, and mixtures thereof. Specific examples include sucrose palmitate or stearate, sucrose oleate, methylcellulose, ethoxylated sorbitan oleate, ethoxylated starch and ethoxylated castor oil. In some embodiments, the concentration of carbohydrate or lipid in the liquid portion of the foam may range from 0.1 to 10 mg/mL, or 0.5 to 8 mg/mL, or 1 to 5 mg/mL.

In some embodiments, the hydrophilic-lipophilic balance (HLB) value of the food grade surfactant may be at least 10, or at least 12, or at least 14.

In some embodiments the gas may comprise one or more gases suitable for maintaining the freshness of the fresh food, including gases used to maintain modified atmospheres in modified atmosphere packaging (MAP) systems. For example, in some embodiments the gas consists of an inert replacement for oxygen, such as nitrogen, carbon dioxide, argon, carbon monoxide, or mixtures thereof. A reduced oxygen or oxygen-free foam composition environment reduces or eliminates aerobic microbial spoilage, oxidative spoilage, and spoilage due to oxidative enzyme activity in fresh food.

In some embodiments, the gas may comprise oxygen to prevent anaerobic microbial spoilage and/or to stabilize pigmentation of certain fresh foods. In some embodiments, the gas may comprise carbon dioxide to decelerate ripening of fresh fruits. In some embodiments, the gas may comprise ethylene or ethylene dioxide to accelerate ripening of fresh fruits.

In some embodiments, the gas or mixture of gas selected depends on factors such as the type of fresh food, the age of the fresh food, the type of receptacle, the amount of fresh food, the form of transportation, the anticipated storage and transportation time, and the like.

In some embodiments, the gas may comprise any commercially available gas, such as nitrous oxide, nitric oxide, helium, xenon and the like.

The aqueous carrier may comprise water. In some embodiments the water may be ozonated water with antimicrobial effect. In some embodiments the aqueous carrier may comprise any other suitable aqueous medium.

In some embodiments the foam composition may be formulated with one or more predetermined factors set at values or value ranges based on the type of fresh food. Examples of these factors of the foam composition include one or more of overrun, yield stress, and pH of the foam.

In some embodiments, the foam composition further comprises a food grade antimicrobial agent. The food grade antimicrobial agent may be an antifungal and/or antibacterial agent. Non-limiting examples of food grade antimicrobial agents include, for example, lysozyme, food-grade acids (acetic acid, lactic acid, malic acid, phosphoric acid, sorbic acid, benzoic acid, and the like), bacteriocins, spice extracts (e.g. turmeric garlic, onion, cinnamon, cloves, thyme, sage, and the like), plant extracts (hop extracts, rosemary extracts, and the like), inorganic salts (e.g., acidified calcium sulfate, tertiary butylhydroquinone, cetyl pyridium chloride, etc.), parabens (e.g. methyl paraben), or mixtures thereof, and the like.

The present inventors have determined advantages of the invention include the following:
Foam facilitates maintenance of predetermined atmospheric conditions for the fresh food when it covers the fresh food. The predetermined atmospheric conditions may at least be partially provided by defining the composition of the gas of the foam as described herein. Maintenance of predetermined atmospheric conditions may be further facilitated by removing air from the volume between the fresh food after coverage with the foam and/or replacing the air between the fresh food with a gas or mixture of gases corresponding to the gas used to generate the foam.
Foam provides thermal insulation for the fresh food through trapped air bubbles and reduced convection.
Foam prevents fresh food from losing moisture.
Foam protects fresh food from light.
Foam is a very light storage and transportation medium.
Foam provides a physical barrier against insect pests.

In embodiments relating to live seafood, the present inventors have determined the following additional advantages:
Foam has moisture which allows respiration by the live seafood.
Foam provides sound insulation to help maintain the live seafood in a calm state.
Foam provides obscures the live seafood's surroundings to provide a sense of “hiding” to help maintain the live seafood in a calm state.
Foam facilitates maintenance of predetermined pH and salinity suitable for the live seafood.

This application is intended to cover any variations, uses, or adaptations of the invention using its general principles. Further, this application is intended to cover such departures from the present disclosure as come within known or customary practice in the art to which this invention pertains and which fall within the limits of the appended claims. Accordingly, the scope of the claims should not be limited by the preferred embodiments set forth in the description, but should be given the broadest interpretation consistent with the description as a whole.

1-36. (canceled)

37. A method for storing and transporting, fresh food, the method comprising:
a) placing fresh food, in a receptacle suitable for storing and transporting fresh food;
b) providing a foam composition comprising:
a. a food grade surfactant;
b. a gas;
c. an aqueous carrier; and
c) at least partially covering the fresh food with the foam composition.

38. A method according to claim 37 wherein step b) comprises adding the aqueous carrier to a dry foaming composition comprising the food grade surfactant.

39. A method according to claim 37 comprising:
d) removing air from between the fresh food under the cover of the foam composition.

40. A method according to claim 39 wherein step d) comprises replacing the air with nitrogen, carbon dioxide, argon, carbon monoxide, or mixtures thereof.

41. A method according to claim 39 wherein the gas comprises nitrogen, carbon dioxide, argon, carbon monoxide, or mixtures thereof, but excludes oxygen.

42. A method according to claim 40 wherein the gas comprises oxygen.

43. A method according to claim 42 wherein the surfactant comprises a native protein selected from the group consisting of frog-derived proteins, carbohydrate-binding proteins, hydrophobias, caseins and denatured proteins.

44. A method according to claim 43 wherein the frog-derived protein is ranasmurfin or a ranaspumin, the carbohydrate-binding protein is a lectin or a mucin, and the denatured protein is soy, whey or albumin.

45. A method according to claim 44 wherein the surfactant comprises an antimicrobial protein.

46. A method according to claim 45 wherein the food grade surfactant comprises a carbohydrate or a lipid.

47. A method according to claim 46 wherein the aqueous carrier comprises fresh water or salt water.

48. A method according to claim 47 wherein the foam composition further comprises a food grade antimicrobial agent.

49. A method according to claim 48 wherein the foam composition of step b) is provided or generated to have one or more predetermined characteristics based on the type of fresh food of step b), wherein the one or more predetermined characteristics are selected from the group consisting of overrun, yield stress, pH and salinity.

50. A method according to claim 49 wherein the receptacle is a box, a tote, a bag or a storage chamber, and the receptacle comprises an interior comprising a smooth surface, a coating providing a smooth surface, or a liner with a smooth surface.

51. A method according to claim 50 wherein the fresh food is selected from the group consisting of live seafood, meat, produce and processed food.

52. A foam composition for storing and transporting fresh food comprising:
a) a food grade surfactant comprising:
a. a protein selected from the group consisting of frog-derived proteins, carbohydrate-binding proteins, hydrophobins, caseins and denatured proteins;
b. a carbohydrate; and/or
c. a lipid;
b) a gas; and
c) an aqueous carrier comprising fresh water or salt water.

53. A composition according to claim 52 wherein the gas comprises nitrogen, carbon dioxide, argon, carbon monoxide, or mixtures thereof, but excludes oxygen.

54. A composition according to claim 52 wherein the gas comprises oxygen.

55. A composition according to claim 52 wherein the frog-derived protein is ranasmurfin or a ranaspumin, the carbohydrate-binding protein is a lectin or a mucin, and the denatured protein is soy, whey or albumin.
